(19) United States
(12) Patent Application Publication
(10) Pub. No.: US 2026/0208471 A1
(43) Pub. Date: Jul. 23, 2026

(54) RECYCLABLE SURFACE-COATED PLASTIC FILM

(71) Applicant: LOPAREX GERMANY GMBH & CO. KG, Forchheim (DE)

(72) Inventors: Patrick ALTMANN, Schöfweg (DE); Christian HERMANN, Eggolsheim (DE); Kilian STENGL, Cadolzburg (DE)

(21) Appl. No.: 19/139,044

(22) PCT Filed: Dec. 19, 2023
(86) PCT No.: PCT/EP2023/086620

§ 371 Date: Jun. 13, 2025

(30) Foreign Application Priority Data
Dec. 19, 2022 (DE) 10 2022 213 879.1

(51) Int. Cl. B32B 27/08; B32B 27/30; B32B 27/32

(52) U.S. Cl. CPC B32B 27/08; B32B 27/306; B32B 27/32; B32B 2250/24; B32B 2255/10; B32B 2255/26; B32B 2307/716; B32B 2307/7166; B32B 2307/718; B32B 2307/7376

(57) ABSTRACT

The invention relates to a plastic film which has a coated surface on at least one face, comprising a carrier film with a first outer layer and a second outer layer; and a first surface coating which covers at least sections of the surface of the first outer layer of the carrier film; wherein the carrier film comprises at least one layer which contains or is based on non-water-soluble polymer; and the plastic film contains water-soluble polymer, wherein (i) the carrier film comprises at least one layer which contains or is based on water-soluble polymer, and/or (ii) the first surface coating contains or is based on a water-soluble polymer.

### CLAIM OF PRIORITY

This application is a national phase filing under 35 USC 371 from PCT Patent Application serial number PCT/EP2023/086620 filed on Dec. 19, 2023 and calaim priority therefrom. This application further claims priority to German patent application No. 10 2022 213 879.1 filed on Dec. 19, 2022. PCT Patent Application serial number PCT/EP2023/086620 and German patent application No. 10 2022 213 879.1 are each incorporated herein by reference in its entirety.

### FIELD

The invention relates to a plastic film which has a coated surface on at least one face, comprising a carrier film with a first outer layer and a second outer layer; and a first surface coating which covers at least sections of the surface of the first outer layer of the carrier film; wherein the carrier film comprises at least one layer which contains or is based on non-water-soluble polymer; and the plastic film contains water-soluble polymer, wherein (i) the carrier film comprises at least one layer which contains or is based on water-soluble polymer, and/or (ii) the first surface coating contains or is based on a water-soluble polymer.

### BACKGROUND

Surface-coated plastic films are used in a wide range of applications. The coatings used include, for example, dehesive silicone coatings, adherent pressure-sensitive adhesive coatings, printing inks, and varnishes.

Such surface-coated films cannot be recycled economically and ecologically in terms of a circular economy. The reason for this is that the surface coatings, such as silicones, pressure-sensitive adhesives, printing inks, or varnishes, cannot be sufficiently separated from the substrate, the actual main raw material.

Recycling the main raw material with coating is opposed to the spirit of a circular economy and usually ends in downcycling or energy recovery. In the spirit of a circular economy, it is therefore necessary that the main raw materials can be separated as cleanly as possible during recycling and then recycled. Using the example of a release film with a dehesive silicone coating, this means removing the silicone from the film.

Various methods for recycling plastic films are known from the prior art. Plastic films that can be recycled have been developed.

DE 41 20 685 A1 discloses a laminate material which contains at least one layer of thermoplastic material and has a latent inherent delamination potential. The layer of thermoplastic material carries a separating layer of water-soluble or water-dispersible organic material on at least one face.

DE 10 2012 006 416 A1 relates to a metal layer-free multilayer film with a weight per unit area of ≤33 g/m², a shrinkage behavior of ≤10% at 90° C. (both in the machine direction and transversely to the machine direction, determined as dimensional change according to DIN 53377), and a layer structure of at least six layers comprising a layer (a) composed of at least one thermoplastic olefin homopolymer or copolymer as one of the outer layers, an adhesion promoter layer (b), a layer (c) composed of at least one homopolyamide and/or copolyamide, at least one internal gas barrier layer (d) adjacent to the layer (c), which differs from the layers (c) and (e) at least in the composition of the polymer component(s); a layer (e) adjacent to the gas barrier layer (d) composed of at least one homopolyamide and/or copolyamide, and a layer (i) composed of at least one homopolyamide and/or copolyamide as one of the outer layers, a use of such a multilayer film for producing a buoyancy body and a buoyancy body made of such a multilayer film.

DE 10 2014 017 015 A1 discloses a multilayer polymer film comprising at least one middle layer A, the polymeric constituents of which are soluble in aqueous solution, and at least one substantially water-impermeable cover layer B, C arranged above and below the at least one middle layer A, wherein the layers A, B, and C independently of one another each contain at least one thermoplastic polymer and at least one of the cover layers B and C contains at least one polyhydroxyalkanoate, as well as methods for producing the multilayer polymer film and its use for producing molded parts, films or bags.

EP 0 569 196 A1 and U.S. Pat. No. 5,419,967 disclose that by adding methacrylate/unsaturated acid and/or vinylamide copolymers, poly(vinyl alcohol) can be melt-processed and co-extruded with structural polymers such as poly(ethylene terephthalate) to form multilayer films and objects with good adhesion between the components and good barrier properties.

EP 0 934 160 B1 relates to a laminated packaging material comprising a layer of paper or cardboard and outer liquid-tight coatings of plastic on both faces of the paper or cardboard web. To facilitate material recycling after use of the laminated packaging material, the packaging material is provided with layers of water-soluble polymer between the paper or cardboard layer and each respective outer plastic coating, the layers acting as an adhesive or binder.

EP 3 885 095 A1 relates to the use of mixtures of water and essential oil for separating multilayer composites for the type-specific recycling of polymer films or metal foils.

US 2018 0369859 A1 relates to films that include a water-soluble layer and a vapor-deposited organic coating. The films show improved barrier properties.

US 2019 0366591 A1 relates to a method for recycling a first polymer from a multi-component polymer product.

US 2020 0055650 A1 relates to films comprising a water-soluble polymer material and a vapor-deposited inorganic coating.

US 2020 0199313 A1 relates to water-soluble films made from copolymers of butenediol and vinyl alcohol, wherein the films have improved barrier properties (such as low transmission rates for oxygen and water vapor) and good solubility.

WO 2000/077082 A1 relates to a process for separating plastic mixtures, with a polyolefinic plastic fraction or a plastic mixture as the starting material, in which the starting material is brought into contact with a solvent and the temperature of the solvent-plastic mixture is adjusted such that a solution with at least one dissolved polymer type is formed, wherein the dissolved polymer type is precipitated from the solution by shearing in order to separate the polymer type from other components of the solution.

WO 2005/118691 A2 relates to a process for recycling polyamides from waste, wherein the waste is mixed with ester solvent and the mixture is heated to a temperature above the melting temperature of the polyolefins contained therein to form a composition containing dissolved polyamide polymer and a separate immiscible liquid polyolefin phase.

WO 2020/136674 A1 relates to a recyclable laminate comprising a first layer and a second layer, wherein each layer is a polyolefin layer having a thickness in the range from 12-100 μm; and an intermediate layer having a thickness in the range from 10-35 μm sandwiched between the first polyolefin layer and the second polyolefin layer, wherein the intermediate layer is a metallized polyolefin film having alcohol-based polymer barrier resins therein.

WO 2021/255544 A1 relates to release liners that can be included in various adhesive products. A first release layer is a layer of a composition comprising a) a polymeric material having at least one hydrogen atom covalently bonded to an oxygen atom, a nitrogen atom, or a sulfur atom; and b) a silicone polyether comprising at least one of polyoxoethylene units or polyoxopropylene units. A second release layer comprises a substrate and a coating of the above composition disposed on a main surface of the substrate. The composition of the release liner can advantageously be dissolved and, if necessary, recycled.

WO 2022/246173A1 discloses a recyclable laminate film structure comprising a release coating. The release coating facilitates the separation of a selected polymer film during recycling by selecting the polymer of the coating composition to have certain Hansen solubility parameters so that the laminate structure delaminates at the layer of the coating, leaving clean pieces of the selected polymer film. In certain embodiments, the release coating is a barrier coating, for example an oxygen barrier coating.

### BRIEF SUMMARY OF THE INVENTION

However, the suitability of the known surface-coated films for use in a circular economy is hardly possible or at least in need of improvement.

One object of the invention was therefore to adapt and improve the design of surface-coated films with a view to a circular economy.

This object is achieved by the subject matter of the claims.

It has surprisingly been found that water-soluble polymers, in particular butenediol-vinyl alcohol copolymer (BVOH) or polyvinyl alcohol (PVOH), can act as a release layer or predetermined breaking point between the film substrate and the surface coating. The focus here is on the use of biodegradable and environmentally friendly water-soluble polymers. The release layer or predetermined breaking point is preferably located on at least one outer face of the substrate, but can also be present within the substrate.

Furthermore, it was found that the application properties of the final product are not impaired to a relevant extent by the introduction of at least one release layer or predetermined breaking point based on water-soluble polymer or can be otherwise compensated for by methods familiar to a person skilled in the art. In terms of a circular economy, the plastic film according to the invention has good recyclability.

A first aspect of the invention relates to a plastic film surface-coated on at least one face, comprising a carrier film with a first outer layer and a second outer layer; and a first surface coating which covers at least sections of the surface of the first outer layer of the carrier film; wherein the carrier film comprises at least one layer which contains or is based on non-water-soluble polymer, preferably polyolefin, polyester, and/or polyamide; and the plastic film contains water-soluble polymer, preferably butenediol-vinyl alcohol copolymer (BVOH) and/or polyvinyl alcohol (PVOH), more preferably butenediol-vinyl alcohol copolymer (BVOH); wherein (i) the carrier film comprises at least one layer which contains or is based on water-soluble polymer, preferably butenediol-vinyl alcohol copolymer (BVOH) and/or polyvinyl alcohol (PVOH), and/or (ii) the first surface coating contains or is based on water-soluble polymer.

### DETAILED DESCRIPTION OF THE INVENTION

In preferred embodiments, the carrier film comprises a layer (a) which is based on water-soluble polymer, preferably butenediol-vinyl alcohol copolymer (BVOH) and/or polyvinyl alcohol (PVOH), and forms the first outer layer of the carrier film; and a layer (c) which is based on non-water-soluble polymer, preferably polyolefin, polyester, and/or polyamide. The layer (a) is disposed between the first surface coating and the layer (c). When used as intended, e.g. in the case of a dehesive first surface coating as a release film with release properties, the release properties of the release film are not significantly impaired by the presence of the layer (a). After the intended use, when the release film with release properties is no longer required and can be sent for proper disposal, layer (a) enables the material of the first surface coating to be separated from the material of layer (c) due to its water solubility and subsequently recycled, in particular [separately] from the material of layer (c), which may be present in type-specific form. When treated in a water bath, optionally at elevated temperature and after a certain exposure time, the plastic film according to the invention can be split along layer (a) into the two materials adjacent to layer (a), that is, into the material of the first surface coating and the material of layer (c), optionally together with other layers with which layer (c) can be present in a composite.

In other preferred embodiments, the carrier film comprises at least one layer which contains or is based on non-water-soluble polymer, preferably polyolefin, polyester and/or polyamide, in a mixture with water-soluble polymer, preferably butenediol-vinyl alcohol copolymer (BVOH) and/or polyvinyl alcohol (PVOH). Even in this case, when used as intended, e.g. as a release film, the release properties of the release film are not significantly impaired by the presence of the water-soluble polymer. After the intended use, when the release film is no longer required and can be disposed of properly, the water-soluble polymer in the layer enables the formation of a predetermined breaking point due to its water solubility. The plastic film according to the invention can then be split along the layer into the two materials adjacent to the layer when treated in a water bath, optionally at an elevated temperature and after a certain exposure time.

Unless expressly stated otherwise, all percentages are by weight. Unless expressly stated otherwise, all percentages refer to the total weight of the plastic film according to the invention.

For descriptive purposes, a layer is “based” on a particular material if that material is the primary constituent of that layer. The weight proportion of the material does not necessarily have to amount to more than 50% by weight of the total weight of the respective layer, but this is preferably the case. Typically, a layer is “based” on a particular material if that material makes up at least 70% by weight, more preferably at least 80% by weight, even more preferably at least 90% by weight, of that layer, in each case based on the total weight of the respective layer.

For the purpose of description, “water soluble” means that the material will dissolve when the composite (the laminate) is placed in a water bath for a sufficient period of time, e.g. 30 minutes, preferably with stirring, and if necessary at an elevated temperature, e.g. 60° C. The water bath can contain common additives, such as surfactants. Accordingly, for the purposes of description, “non-water soluble” means that the material does not dissolve under the conditions specified above.

Preferably, a measuring method is used to determine whether a polymer is water-soluble or non-water-soluble within the meaning of the invention. The water solubility of polymers is preferably determined according to OECD Guideline 105 as amended on Jul. 27, 1995. Alternatively, reference may be made to OECD Guideline 120 as amended on Jan. 21, 2000. The water solubility of polymers is determined according to COMMISSION REGULATION (EC) No 440/2008 of May 30, 2008 laying down test methods pursuant to Regulation (EC) No 1907/2006 of the European Parliament and of the Council concerning the Registration, Evaluation, Authorisation and Restriction of Chemicals (REACH), as amended on Mar. 4, 2016, by method A.6 “Water solubility,” which corresponds to OECD Test Guideline (TG) 105 (1995).

Preferably, “water-soluble” means a solubility in pure water at 20.0±0.5° C. of at least 2.0 g/L; accordingly, “water-insoluble” preferably means a solubility of less than 2.0 g/L. This solubility limit was also chosen by the European Chemicals Agency (ECHA) (see Opinion on an Annex XV dossier proposing restrictions on intentionally-added microplastics of Jun. 11, 2020).

Preferably, the water-soluble polymers according to the invention have a water solubility under the conditions mentioned which is significantly above the limit value of 2.0 g/L, preferably at least 5.0 g/L; more preferably at least 10 g/L, even more preferably at least 15 g/L, most preferably at least 20 g/L, and in particular at least 25 g/L.

Water-soluble polymers according to the invention are preferably miscible with water in a practically unlimited manner, in particular at elevated temperatures, but then form gels above a certain concentration, the viscosity of which may increase significantly.

In preferred embodiments, the water-soluble polymers according to the invention have a solubility such that the polymer is practically completely dissolved at a concentration of 10% by weight in pure water with stirring and continuous heating from 20° C. to 85° C. at a heating rate of 1° C./min after no more than 40 minutes (i.e. when 60° C. is reached), preferably after no more than 30 minutes (i.e. when 50° C. is reached). This requirement is met, for example, by products under the name Nichigo G-Polymer®.

In preferred embodiments, the water-soluble polymers according to the invention have a solubility such that the polymer is practically completely dissolved after 2 hours at the latest at a concentration of 5.0% by weight in pure water with stirring at 20° C. This requirement is met, for example, by the product called Nichigo G-Polymer® AZF8035W.

In preferred embodiments, the water-soluble polymers according to the invention have a solubility such that the polymer is practically completely dissolved after 1 hour at the latest at a concentration of 5.0% by weight in pure water with stirring at a temperature of 70° C. This requirement is met, for example, by products under the names Nichigo G-Polymer® AZF8035W, OKS-1001, and OKS 8074P.

In preferred embodiments, the water-soluble polymers according to the invention have a solubility such that the polymer is practically completely dissolved after 1 hour at the latest at a concentration of 5.0% by weight in pure water with stirring at a temperature of 90° C. This requirement is met, for example, by products under the names Nichigo G-Polymer® AZF8035W, OKS-1001, and OKS 8074P.

In preferred embodiments, a film with a layer thickness of 200 μm which consists of the pure water-soluble polymer dissolves completely in a sufficient amount of water at 25° C. and with stirring within 6 minutes. These requirements are met, for example, by Mowiflex® types C17, C30, C600, C130T, and C500T.

Preferably, the non-water-soluble polymers according to the invention have a water solubility under the conditions mentioned which is significantly below the limit value of 2.0 g/L (2000 mg/L), preferably at most 1000 mg/L; more preferably at most 500 mg/L, even more preferably at most 100 mg/L, most preferably at most 50 mg/L, and in particular at most 10 mg/L.

For the purposes of the invention, a polymer is preferably considered to be water-soluble if at least 50 g of this polymer can be homogenized in one liter of pure water at 25° C.

For the purposes of the invention and regardless of a numerically quantified solubility (e.g. in g/L or mg/L), polyolefins, anhydride-modified polyolefins, acid-modified polyolefins, polyesters, and polyamides are preferably considered non-water-soluble polymers, and butenediol-vinyl alcohol copolymers (BVOH) and polyvinyl alcohols (PVOH) are considered water-soluble polymers. Suitable water-soluble polymers within the meaning of the invention are commercially available, for example under the names Nichigo G-Polymer® and Mowiflex®.

If the water-soluble polymer according to the invention is a butenediol-vinyl alcohol copolymer (BVOH) or a polyvinyl alcohol (PVOH), vinyl acetate was typically used as a (co-)monomer in the polymerization, and its ester groups were subsequently at least partially saponified. According to the invention, the degree of saponification is preferably at least 80 mol %, more preferably at least 85 mol %, even more preferably at least 90 mol %, most preferably at least 95 mol %, and in particular about 100 mol %, independently of one another. It may be preferred that the degree of saponification is not complete, for example at most 99 mol %, or at most 98 mol %, or at most 97 mol %.

Butenediol-vinyl alcohol copolymers (BVOH) preferred according to the invention have a melt flow index (MFI) at 210° C. and 2160 g in the range from 0.5 to 35 g/10 min, more preferably in the range from 1.0 to 30 g/10 min, even more preferably in the range from 1.5 to 20 g/10 min, most preferably in the range from 2.0 to 10 g/10 min, and in particular in the range from 2.5 to 5.0 g/10 min.

Polyvinyl alcohols (PVOH) preferred according to the invention have a melt flow index (MFI) at 190° C. and 2160 g in the range from 0.5 to 50 g/10 min, more preferably in the range from 1.0 to 45 g/10 min, even more preferably in the range from 1.5 to 40 g/10 min, most preferably in the range from 2.0 to 35 g/10 min, and in particular in the range from 2.5 to 30 g/10 min.

According to the invention, it is possible to use mixtures of multiple water-soluble polymers, for example multiple polyvinyl alcohols (PVOH) with different degrees of saponification, multiple butenediol-vinyl alcohol copolymers (BVOH) with different degrees of saponification, or also mixtures of polyvinyl alcohols (PVOH) with butenediol-vinyl alcohol copolymers (BVOH).

It is possible that the plastic film according to the invention comprises other layers in addition to the necessarily present layers and the optional layers. However, the plastic film according to the invention preferably consists of the necessarily present layers and optionally one or more of the optional layers.

Preferably, the carrier film comprises at least one layer which contains or is based on water-soluble polymer, preferably butenediol-vinyl alcohol copolymer (BVOH) and/or polyvinyl alcohol (PVOH), wherein the plastic film can be split along this layer when treated in a water bath, optionally at an elevated temperature and after a sufficient exposure time.

In preferred embodiments of the plastic film according to the invention, the first surface coating is dehesive.

For the purpose of description, “dehesive” means a release force according to FINAT test method FTM10 (Tesa® test tape 7475, peel speed 300 mm/min, storage conditions 20 h/70° C.) of not more than 50 cN/cm, more preferably not more than 40 cN/cm, even more preferably not more than 30 cN/cm.

Preferably, the first surface coating is based on polysiloxane.

In preferred embodiments of the plastic film according to the invention, the first surface coating is based on at least one cured polysiloxane, which is preferably selected from the group consisting of addition-crosslinked, preferably metal-catalyzed addition-crosslinked, condensation-crosslinked, free radical-crosslinked, and/or cationically crosslinked polysiloxanes.

In preferred embodiments of the plastic film according to the invention, the first surface coating is based on at least one cured polysiloxane, which is preferably selected from the group consisting of polydialkylsiloxanes, preferably polydimethylsiloxanes, and polyalkylarylsiloxanes, preferably polymethylphenylsiloxanes.

In other preferred embodiments of the plastic film according to the invention, the first surface coating is adhesive.

Preferably, the first surface coating is based on a pressure-sensitive adhesive.

In preferred embodiments of the plastic film according to the invention, the pressure-sensitive adhesive is selected from the group consisting of acrylate-based pressure-sensitive adhesives, rubber-based pressure-sensitive adhesives, polyisobutylene-based pressure-sensitive adhesives, and hot melts.

In further preferred embodiments of the plastic film according to the invention, the first surface coating is based on printing ink or varnish.

In preferred embodiments of the plastic film according to the invention, in particular when the first surface coating is dehesive, the first surface coating has a weight per unit area of at most 5.0 g/m², more preferably at most 4.0 g/m², even more preferably at most 3.0 g/m², most preferably at most 2.0 g/m², and in particular at most 1.0 g/m². The weight per unit area is preferably determined according to FINAT test method FTM7.

In other preferred embodiments of the plastic film according to the invention, in particular when the first surface coating is adhesive, the first surface coating has a weight per unit area of at most 100 g/m², more preferably at most 80 g/m², even more preferably at most 60 g/m², most preferably at most 40 g/m², and in particular at most 20 g/m². The weight per unit area is also preferably determined according to FINAT.

The first surface coating can cover the surface of the first outer face of the carrier film according to the invention partially or completely, preferably completely. In order to ensure sufficient resistance to moisture or wetness for the application, the surface coating should be applied so as to cover as completely as possible. In the case of partially coated surfaces, it is therefore advisable to use a varnish which can, for example, be printed over the entire surface to cover the areas covered with the first surface coating as well as the areas not covered by the first surface coating.

In preferred embodiments of the plastic film according to the invention, the second surface coating is dehesive.

Preferably, the second surface coating is based on polysiloxane.

In preferred embodiments of the plastic film according to the invention, the second surface coating is based on at least one cured polysiloxane, which is preferably selected from the group consisting of addition-crosslinked, preferably metal-catalyzed addition-crosslinked, condensation-crosslinked, free radical-crosslinked, and/or cationically crosslinked polysiloxanes.

In preferred embodiments of the plastic film according to the invention, the second surface coating is based on at least one cured polysiloxane, which is preferably selected from the group consisting of polydialkylsiloxanes, preferably polydimethylsiloxanes, and polyalkylarylsiloxanes, preferably polymethylphenylsiloxanes.

In other preferred embodiments of the plastic film according to the invention, the second surface coating is adhesive.

Preferably, the second surface coating is based on a pressure-sensitive adhesive.

Preferably, the pressure-sensitive adhesive is selected from the group consisting of acrylate-based pressure-sensitive adhesives, rubber-based pressure-sensitive adhesives, polyisobutylene-based pressure-sensitive adhesives, and hot melts.

In further preferred embodiments of the plastic film according to the invention, the second surface coating is based on printing ink or varnish.

In preferred embodiments of the plastic film according to the invention, in particular when the second surface coating is dehesive, the second surface coating has a weight per unit area of at most 5.0 g/m², more preferably at most 4.0 g/m², even more preferably at most 3.0 g/m², most preferably at most 2.0 g/m², and in particular at most 1.0 g/m². The weight per unit area is preferably determined according to FINAT test method FTM7.

In preferred embodiments of the plastic film according to the invention, in particular when the second surface coating is adhesive, the second surface coating has a weight per unit area of at most 100 g/m², more preferably at most 80 g/m², even more preferably at most 60 g/m², most preferably at most 40 g/m², and in particular at most 20 g/m². The weight per unit area is also preferably determined according to FINAT.

The second surface coating can cover the surface of the second outer face of the carrier film according to the invention partially or completely, preferably completely. In order to ensure sufficient resistance to moisture or wetness for the application, the surface coating should be applied so as to cover as completely as possible. In the case of partially coated surfaces, it is therefore advisable to use a varnish which can, for example, be printed over the entire surface to cover the areas covered with the second surface coating as well as the areas not covered by the second surface coating.

In preferred embodiments, the plastic film according to the invention is a plastic film which is surface-coated on at least one face and which comprises or consists of
a carrier film having a first outer layer and a second outer layer;
a first surface coating which covers at least part of the surface of the first outer layer of the carrier film; and
optionally, a second surface coating, which optionally covers at least part of the surface of the second outer layer of the carrier film;
   wherein the carrier film comprises or consists of
   (a) a layer (a) which is based on water-soluble polymer, preferably butenediol-vinyl alcohol copolymer (BVOH) and/or polyvinyl alcohol (PVOH), and forms the first outer layer of the carrier film;
   (b) optionally an adhesion promoter layer (b);
   (c) a layer (c) based on non-water-soluble polymer, preferably polyolefin, polyester, and/or polyamide;
   (d) optionally an adhesion promoter layer (d);
   (e) optionally, a layer (e) which is based on water-soluble polymer, preferably butenediol-vinyl alcohol copolymer (BVOH) and/or polyvinyl alcohol (PVOH);
   (f) a layer (f) based on non-water-soluble polymer, preferably polyolefin, polyester, and/or polyamide;
   (g) a layer (g) which is based on water-soluble polymer, preferably butenediol-vinyl alcohol copolymer (BVOH) and/or polyvinyl alcohol (PVOH).

The first surface coating as well as layers (a) and (c) of the plastic film according to the invention are necessarily present. The second surface coating and layers (b), (d), (e), (f), and (g) are each independently optional. Preferably, those of the existing layers are arranged in alphabetical order.

According to these embodiments of the invention, layer (a) and optionally also layer (e) are based on water-soluble polymer, preferably butenediol-vinyl alcohol copolymer (BVOH) and/or polyvinyl alcohol (PVOH). Layer (a) and any optionally additionally present layer (e) do not significantly impair the functioning of the plastic film according to the invention when it is used as intended, e.g. as a release film with release properties. However, if the plastic film according to the invention is introduced into methods for the recovery of raw materials used (recycling), layer (a) and the optionally additionally present layer (e) contribute significantly to the fact that individual components of the plastic film can be separated from one another.

In preferred embodiments of the plastic film according to the invention, layer (a) is based on extrudable, water-soluble polymer, preferably butenediol-vinyl alcohol copolymer (BVOH) and/or polyvinyl alcohol (PVOH).

Butenediol-vinyl alcohol copolymer (BVOH) is particularly preferred according to the invention because it can be extruded particularly advantageously and can therefore be processed, for example, by blown film coextrusion and at the same time has particularly good water solubility. In this respect, butenediol-vinyl alcohol copolymer (BVOH) is particularly advantageous compared to polyvinyl alcohol (PVOH) and polyvinyl acetate (PVA).

Preferably, layer (a) is based on one or more water-soluble polymers independently selected from
(i) fully synthetic water-soluble polymers; and
(ii) semi-synthetic or natural water-soluble polymers.

Preferably, layer (a) is based on one or more water-soluble polymers selected from polymers or copolymers of vinyl acetate, vinylpyrrolidone, ethylene oxide, acrylamide, and lactic acid; preferably polymers or copolymers of vinyl acetate.

In preferred embodiments of the plastic film according to the invention, layer (a) is based on one or more water-soluble polymers independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, layer (a) is based on one or more water-soluble polymers having an ethylene group content of at most 10 mol %, more preferably at most 5.0 mol %, even more preferably at most 2.5 mol %, and in particular practically no ethylene groups at all.

Preferably, layer (a) is based on one or more water-soluble polymers having a vinyl ester group content of at most 20 mol %, more preferably at most 15 mol %, even more preferably at most 10 mol %, most preferably at most 5.0 mol %, and in particular at most 2.5 mol %.

Preferably, layer (a) is based on one or more water-soluble polymers having a vinyl alcohol group content in the range from 40 to 85 mol %, preferably 50 to 75 mol %.

Preferably, layer (a) is based on one or more water-soluble polymers having a butylene group content in the range from 15 to 60 mol %, preferably 25 to 50 mol %.

In preferred embodiments, layer (a) contains at least 50% by weight water-soluble polymer, more preferably at least 60% by weight, even more preferably at least 70% by weight, most preferably at least 80% by weight, and in particular at least 90% by weight, based on the total weight of layer (a).

Preferably, layer (a) contains at most 10% by weight of non-water-soluble polymer, more preferably 5% by weight, even more preferably at most 2.5% by weight, most preferably at most 1.0% by weight, based on the total weight of layer (a), and in particular practically no non-water-soluble polymer at all.

Preferably, layer (a) has a layer thickness in the range from 0.5 to 100 μm, preferably 0.5 to 25 μm.

In preferred embodiments of the plastic film according to the invention, layer (a) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, layer (a) has a layer thickness of at most 22 μm, more preferably at most 19 μm, even more preferably at most 16 μm, most preferably at most 13 μm, and in particular at most 10 μm.

In preferred embodiments of the plastic film according to the invention, layer (a) has a layer thickness of at least 9.0 μm, more preferably at least 8.0 μm, even more preferably at least 7.0 μm, most preferably at least 6.0 μm, and in particular at least 5.0 μm.

In preferred embodiments of the plastic film according to the invention, layer (a) has a layer thickness of at least 4.0 μm, more preferably at least 3.0 μm, even more preferably at least 2.5 μm, most preferably at least 2.0 μm, and in particular at least 1.75 μm.

In preferred embodiments of the plastic film according to the invention, the adhesion promoter layer (b) is based on anhydride-modified or acid-modified polyolefin.

In addition to the anhydride-modified or acid-modified polyolefin, the adhesion promoter layer (b) may optionally contain other polymers, preferably those polymers which are contained in one of the layers adjacent to the adhesion promoter layer (b), i.e., the same water-soluble polymer which is contained in layer (a) and/or the same non-water-soluble polymer which is contained in layer (c).

In preferred embodiments, the adhesion promoter layer (b) contains at least 30% by weight non-water-soluble polymer, more preferably at least 40% by weight, even more preferably at least 50% by weight, most preferably at least 60% by weight, and in particular at least 70% by weight, based on the total weight of the adhesion promoter layer (b).

Preferably, the adhesion promoter layer (b) has a layer thickness in the range from 0.5 to 25 μm, preferably 0.5 to 10 μm.

In preferred embodiments of the plastic film according to the invention, the adhesion promoter layer (b) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, the adhesion promoter layer (b) has a layer thickness of at least 9.0 μm, more preferably at least 8.0 μm, even more preferably at least 7.0 μm, most preferably at least 6.0 μm, and in particular at least 5.0 μm.

In preferred embodiments of the plastic film according to the invention, layer (c) is based on one or more non-water-soluble polymers independently selected from the group consisting of polyolefins, polyesters, and polyamides.

Preferably, layer (c) is based on one or more non-water-soluble polymers independently selected from
thermoplastic olefin homopolymers; and/or
thermoplastic olefin copolymers of α,β-unsaturated olefins having 2 to 10 carbon atoms.

Preferably, layer (c) is based on one or more non-water-soluble polymers independently selected from the group consisting of polyethylene, polypropylene, polybutylene, polyisobutylene (PI), copolymers and/or mixtures of at least two of the polymers mentioned.

In preferred embodiments, layer (c) contains at least 50% by weight water-soluble polymer, more preferably at least 60% by weight, even more preferably at least 70% by weight, most preferably at least 80% by weight, and in particular at least 90% by weight, based on the total weight of layer (c).

Preferably, layer (c) contains at most 10% by weight of water-soluble polymer, more preferably 5% by weight, even more preferably at most 2.5% by weight, most preferably at most 1.0% by weight, based on the total weight of layer (a), and in particular practically no water-soluble polymer at all.

In preferred embodiments, layer (c) comprises multiple plies (c₁), (c₂), etc.

In particularly preferred embodiments, layer (c) is at least three-ply and comprises ply (c₁), ply (c₂), and ply (c₃), wherein ply (c₂) is disposed between plies (c₁) and (c₃). Preferably, plies (c₁) and (c₃) are based on the same non-water-soluble polymer, which preferably differs from the non-water-soluble polymer on which ply (c₂) is based.

In preferred embodiments, the layer (c) or the ply (c₂) is based on polyolefin, preferably olefin homopolymer or copolymer, which is preferably selected from the group consisting of polyethylene, polypropylene, polybutylene, polyisobutylene, polyhexene, polyoctene, copolymers and/or mixtures of at least two of the polymers mentioned.

Preferably, the olefin homopolymer or copolymer of layer (c) or ply (c₂) is an ethylene homopolymer or an ethylene copolymer.

Preferably, the ethylene homopolymer or copolymer of the layer (c) or the ply (c₂) is selected from the group consisting of low density polyethylene (LDPE), linear low density polyethylene (LLDPE), medium density polyethylene (MDPE), and high density polyethylene (HDPE).

Ethylene homopolymers or copolymers are understood to mean ethylene homopolymers which are based exclusively on ethylene and ethylene copolymers which, in addition to ethylene, are based on at least one other α,β-unsaturated olefin having 3 to 10 carbon atoms. Preferred ethylene homopolymers or copolymers are polyethylene with highly branched polymer chains and a low density in the range from 0.915 to 0.940 g/cm³ (LDPE); polyethylene with an average density in the range from 0.926 to 0.940 g/cm³ (MDPE); polyethylene with slightly branched polymer chains and a high density in the range from 0.945 to 0.97 g/cm³ (HDPE); and linear low-density polyethylene with short branched polymer chains, which in addition to ethylene as a comonomer can contain one or more higher α,β-unsaturated olefins such as butylene, hexene, or octene, with a density in the range from 0.915 to 0.94 g/cm³ (LLDPE).

Preferably, the polyolefin on which the layer (c) or the ply (c₂) is based comprises a mixture of an ethylene homopolymer or copolymer and a propylene homopolymer or copolymer.

In preferred embodiments, the polyolefin on which the layer (c) or the ply (c₂) is based comprises a mixture of
51 to 85% by weight of an ethylene homopolymer or copolymer having a density in the range from 0.91 to 0.97 g/cm³; and
15 to 49% by weight of a propylene homopolymer or copolymer;
   respectively based on the total weight of the mixture.

Propylene homopolymers or copolymers are understood to mean propylene homopolymers which are based exclusively on propylene and propylene copolymers which, in addition to propylene, are based on at least one other α,β-unsaturated olefin having 2 to 10 carbon atoms. Preferred propylene homopolymers are isotactic propylene homopolymers, preferably having a melting point in the range from 140 to 170° C. Preferred propylene copolymers are copolymers of propylene and ethylene, wherein the proportion of ethylene is preferably at most 20% by weight, based on the total weight of the propylene copolymer.

In preferred embodiments, the layer (c) or the ply (c₂) consists of LDPE and a propylene homopolymer or copolymer.

In other preferred embodiments, the layer (c) or the ply (c₂) consists of LLDPE and a propylene homopolymer or copolymer.

Preferably, the layer (c) or the plies (c₁) and (c₃) are each independently based on
polyolefin, wherein the polyolefin is selected from the group consisting of olefin homopolymers or copolymers of α,β-unsaturated olefins having 2 to 10 carbon atoms; or
an ethylene-vinyl acetate copolymer.

In preferred embodiments, the layer (c) or the plies (c₁) and (c₃) are each independently based on an ethylene-vinyl acetate copolymer.

In other preferred embodiments, the layer (c) or the plies (c₁) and (c₃) are each independently based on polyolefin, wherein the polyolefin is selected from the group consisting of olefin homopolymers or copolymers of α,β-unsaturated olefins having 2 to 10 carbon atoms.

In these preferred embodiments, the polyolefin of layer (c) or the plies (c₁) and (c₃) is preferably selected, each independently of one another, from the group consisting of polyethylene, polypropylene, polybutylene, polyisobutylene, polyhexene, polyoctene, copolymers, and/or mixtures of at least two of the polymers mentioned.

Preferably, the olefin homopolymer or copolymer of layer (c) or the plies (c₁) and (c₃) is each independently an ethylene homopolymer or an ethylene copolymer.

Preferably, the ethylene homopolymer or copolymer of the layer (c) or the plies (c₁) and (c₃) is selected from the group consisting of low density polyethylene (LDPE), linear low density polyethylene (LLDPE), medium density polyethylene (MDPE), and high density polyethylene (HDPE), and mixtures thereof.

Preferably, the layer (c) or the plies (c₁) and (c₃) each independently consist of a mixture of two ethylene homopolymers or copolymers, preferably of a mixture of LDPE with LLDPE, MDPE, or HDPE. The proportion of LDPE is preferably in the range from 10 to 85% by weight and the proportion of the second ethylene homopolymer or copolymer is preferably in the range from 15 to 90% by weight.

Preferably, layer (c) has a layer thickness in the range from 0.5 to 100 μm, preferably 0.5 to 25 μm.

In preferred embodiments of the plastic film according to the invention, layer (c) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, layer (c) has a layer thickness of at most 22 μm, more preferably at most 19 μm, even more preferably at most 16 μm, most preferably at most 13 μm, and in particular at most 10 μm.

In preferred embodiments of the plastic film according to the invention, the adhesion promoter layer (d) is based on anhydride-modified or acid-modified polyolefin.

In addition to the anhydride-modified or acid-modified polyolefin, the adhesion promoter layer (d) may optionally contain other polymers, preferably those polymers which are contained in one of the layers adjacent to the adhesion promoter layer (d), i.e., the same water-soluble polymer which is contained in layer (e) and/or the same non-water-soluble polymer which is contained in layer (c).

In preferred embodiments, the adhesion promoter layer (d) contains at least 30% by weight non-water-soluble polymer, more preferably at least 40% by weight, even more preferably at least 50% by weight, most preferably at least 60% by weight, and in particular at least 70% by weight, based on the total weight of the adhesion promoter layer (d).

Preferably, the adhesion promoter layer (d) has a layer thickness in the range from 0.5 to 25 μm, preferably 0.5 to 10 μm.

In preferred embodiments of the plastic film according to the invention, the adhesion promoter layer (d) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, the adhesion promoter layer (d) has a layer thickness of at least 9.0 μm, more preferably at least 8.0 μm, even more preferably at least 7.0 μm, most preferably at least 6.0 μm, and in particular at least 5.0 μm.

In preferred embodiments of the plastic film according to the invention, the adhesion promoter layer (d) has the same layer structure as the adhesion promoter layer (b).

In preferred embodiments of the plastic film according to the invention, the adhesion promoter layer (d) has a different layer structure than the adhesion promoter layer (b).

In preferred embodiments of the plastic film according to the invention, layer (e) is based on extrudable, water-soluble polymer, preferably butenediol-vinyl alcohol copolymer (BVOH) and/or polyvinyl alcohol (PVOH).

Preferably, layer (e) is based on one or more water-soluble polymers independently selected from
(i) fully synthetic water-soluble polymers; or
(ii) semi-synthetic or natural water-soluble polymers.

Preferably, layer (e) is based on one or more water-soluble polymers selected from polymers or copolymers of vinyl acetate, vinylpyrrolidone, ethylene oxide, acrylamide, and lactic acid; preferably polymers or copolymers of vinyl acetate.

Preferably, layer (e) is based on one or more water-soluble polymers independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, layer (e) is based on one or more water-soluble polymers having an ethylene group content of at most 10 mol %, more preferably at most 5.0 mol %, even more preferably at most 2.5 mol %, and in particular practically no ethylene groups at all.

Preferably, layer (e) is based on one or more water-soluble polymers having a vinyl ester group content of at most 20 mol %, more preferably at most 15 mol %, even more preferably at most 10 mol %, most preferably at most 5.0 mol %, and in particular at most 2.5 mol %.

Preferably, layer (e) is based on one or more water-soluble polymers having a vinyl alcohol group content in the range from 40 to 85 mol %, preferably 50 to 75 mol %.

Preferably, layer (e) is based on one or more water-soluble polymers having a butylene group content in the range from 15 to 60 mol %, preferably 25 to 50 mol %.

In preferred embodiments, layer (e) contains at least 50% by weight of water-soluble polymer, more preferably at least 60% by weight, even more preferably at least 70% by weight, most preferably at least 80% by weight, and in particular at least 90% by weight, based on the total weight of layer (e).

Preferably, layer (e) contains at most 10% by weight of non-water-soluble polymer, more preferably 5% by weight, even more preferably at most 2.5% by weight, most preferably at most 1.0% by weight, based on the total weight of layer (e), and in particular practically no non-water-soluble polymer at all.

Preferably, layer (e) has a layer thickness in the range from 0.5 to 100 μm, preferably 0.5 to 25 μm.

In preferred embodiments of the plastic film according to the invention, layer (e) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, layer (e) has a layer thickness of at most 22 μm, more preferably at most 19 μm, even more preferably at most 16 μm, most preferably at most 13 μm, and in particular at most 10 μm.

In preferred embodiments of the plastic film according to the invention, layer (e) has a layer thickness of at least 9.0 μm, more preferably at least 8.0 μm, even more preferably at least 7.0 μm, most preferably at least 6.0 μm, and in particular at least 5.0 μm.

In preferred embodiments of the plastic film according to the invention, layer (e) has a layer thickness of at least 4.0 μm, more preferably at least 3.0 μm, even more preferably at least 2.5 μm, most preferably at least 2.0 μm, and in particular at least 1.75 μm.

In preferred embodiments of the plastic film according to the invention, layer (e) has the same layer structure as layer (a).

In preferred embodiments of the plastic film according to the invention, layer (e) has a different layer structure than layer (a).

In preferred embodiments of the plastic film according to the invention, layer (f) is based on one or more non-water-soluble polymers independently selected from the group consisting of polyolefins, polyesters, and polyamides.

Preferably, layer (f) is based on one or more non-water-soluble polymers independently selected from
thermoplastic olefin homopolymers; and/or
thermoplastic olefin copolymers of α,β-unsaturated olefins having 2 to 10 carbon atoms.

Preferably, layer (f) is based on one or more non-water-soluble polymers independently selected from the group consisting of polyethylene, polypropylene, polybutylene, polyisobutylene (PI), copolymers and/or mixtures of at least two of the polymers mentioned.

In preferred embodiments, layer (f) contains at least 50% by weight of water-soluble polymer, more preferably at least 60% by weight, even more preferably at least 70% by weight, most preferably at least 80% by weight, and in particular at least 90% by weight, based on the total weight of layer (f).

Preferably, layer (f) contains at most 10% by weight of water-soluble polymer, more preferably 5% by weight, even more preferably at most 2.5% by weight, most preferably at most 1.0% by weight, based on the total weight of layer (f), and in particular practically no water-soluble polymer at all.

Preferably, layer (f) has a layer thickness in the range from 0.5 to 100 μm, preferably 0.5 to 25 μm.

In preferred embodiments of the plastic film according to the invention, layer (f) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, layer (f) has a layer thickness of at most 22 μm, more preferably at most 19 μm, even more preferably at most 16 μm, most preferably at most 13 μm, and in particular at most 10 μm.

In preferred embodiments of the plastic film according to the invention, layer (f) has the same layer structure as layer (c).

In preferred embodiments of the plastic film according to the invention, layer (f) has a different layer structure than layer (c).

In preferred embodiments of the plastic film according to the invention, layer (g) is based on extrudable, water-soluble polymer, preferably butenediol-vinyl alcohol copolymer (BVOH) and/or polyvinyl alcohol (PVOH).

Preferably, layer (g) is based on one or more water-soluble polymers independently selected from
(i) fully synthetic water-soluble polymers; or
(ii) semi-synthetic or natural water-soluble polymers.

Preferably, layer (g) is based on one or more water-soluble polymers selected from polymers or copolymers of vinyl acetate, vinylpyrrolidone, ethylene oxide, acrylamide, and lactic acid; preferably polymers or copolymers of vinyl acetate.

Preferably, layer (g) is based on one or more water-soluble polymers independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, layer (g) is based on one or more water-soluble polymers having an ethylene group content of at most 10 mol %, more preferably at most 5.0 mol %, even more preferably at most 2.5 mol %, and in particular practically no ethylene groups at all.

Preferably, layer (g) is based on one or more water-soluble polymers having a vinyl ester group content of at most 20 mol %, more preferably at most 15 mol %, even more preferably at most 10 mol %, most preferably at most 5.0 mol %, and in particular at most 2.5 mol %.

Preferably, layer (g) is based on one or more water-soluble polymers having a vinyl alcohol group content in the range from 40 to 85 mol %, preferably 50 to 75 mol %.

Preferably, layer (g) is based on one or more water-soluble polymers having a butylene group content in the range from 15 to 60 mol %, preferably 25 to 50 mol %.

In preferred embodiments, layer (g) contains at least 50% by weight water-soluble polymer, more preferably at least 60% by weight, even more preferably at least 70% by weight, most preferably at least 80% by weight, and in particular at least 90% by weight, based on the total weight of layer (g).

Preferably, layer (g) contains at most 10% by weight of non-water-soluble polymer, more preferably 5% by weight, even more preferably at most 2.5% by weight, most preferably at most 1.0% by weight, based on the total weight of layer (g), and in particular practically no non-water-soluble polymer at all.

Preferably, layer (g) has a layer thickness in the range from 0.5 to 100 μm, preferably 0.5 to 25 μm.

In preferred embodiments of the plastic film according to the invention, layer (g) has a layer thickness of at least 1.0 μm, more preferably at least 2.0 μm, even more preferably at least 3.0 μm, most preferably at least 4.0 μm, and in particular at least 5.0 μm.

In preferred embodiments of the plastic film according to the invention, layer (g) has a layer thickness of at most 22 μm, more preferably at most 19 μm, even more preferably at most 16 μm, most preferably at most 13 μm, and in particular at most 10 μm.

In preferred embodiments of the plastic film according to the invention, layer (g) has a layer thickness of at least 9.0 μm, more preferably at least 8.0 μm, even more preferably at least 7.0 μm, most preferably at least 6.0 μm, and in particular at least 5.0 μm.

In preferred embodiments of the plastic film according to the invention, layer (g) has a layer thickness of at least 4.0 μm, more preferably at least 3.0 μm, even more preferably at least 2.5 μm, most preferably at least 2.0 μm, and in particular at least 1.75 μm.

In preferred embodiments of the plastic film according to the invention, layer (g) has the same layer structure as layer (e).

In preferred embodiments of the plastic film according to the invention, layer (g) has a different layer structure than layer (e).

In preferred embodiments of the plastic film according to the invention, the plastic film has a total layer thickness in the range from 10 to 250 μm.

The plastic film preferably has a total layer thickness of at least 20 μm, more preferably at least 25 μm, even more preferably at least 30 μm, most preferably at least 35 μm and in particular at least 40 μm.

The plastic film preferably has a total layer thickness of at most 90 μm, more preferably at most 80 μm, even more preferably at most 70 μm, most preferably at most 60 μm and in particular at most 50 μm.

Preferably, the plastic film according to the invention is extrudable, preferably coextrudable in one step, more preferably by blown film coextrusion.

In preferred embodiments of the plastic film according to the invention, the carrier film has a symmetrical layer structure.

Preferably, layer (b) is disposed between layer (a) and layer (c); preferably, it is in direct contact with layer (a) and/or with layer (c).

Preferably, layer (c) is disposed between layer (b) and layer (d); preferably, it is in direct contact with layer (b) and/or with layer (d).

Preferably, layer (d) is disposed between layer (c) and layer (e); preferably, it is in direct contact with layer (c) and/or with layer (e).

Preferably, layer (e) is disposed between layer (d) and layer (f); preferably, it is in direct contact with layer (d) and/or with layer (f).

Preferably, layer (f) is disposed between layer (e) and layer (g); preferably, it is in direct contact with layer (e) and/or with layer (g).

In preferred embodiments, the plastic film according to the invention has the following structure:
first surface coating;
layer (a), which is based on water-soluble polymer, preferably butenediol-vinyl alcohol copolymer (BVOH) and/or polyvinyl alcohol (PVOH), and forms the first outer layer of the carrier film;
adhesion promoter layer (b); and
layer (c), which is based on non-water soluble polymer, preferably polypropylene.

In further preferred embodiments, the plastic film according to the invention has the following structure:
first surface coating;
layer (a), which is based on water-soluble polymer, preferably butenediol-vinyl alcohol copolymer (BVOH) and/or polyvinyl alcohol (PVOH), and forms the first outer layer of the carrier film;
adhesion promoter layer (b);
layer (c), which is based on non-water soluble polymer, preferably polypropylene;
adhesion promoter layer (d);
layer (e), which is based on water-soluble polymer, preferably butenediol-vinyl alcohol copolymer (BVOH), and/or polyvinyl alcohol (PVOH); and
second surface coating.

In other preferred embodiments, the plastic film according to the invention has the following structure:
first surface coating;
layer (a), which is based on water-soluble polymer, preferably butenediol-vinyl alcohol copolymer (BVOH) and/or polyvinyl alcohol (PVOH), and forms the first outer layer of the carrier film;
adhesion promoter layer (b);
layer (c), which is based on non-water soluble polymer, preferably polypropylene; adhesion promoter layer (d);
layer (e), which is based on water-soluble polymer, preferably butenediol-vinyl alcohol copolymer (BVOH), and/or polyvinyl alcohol (PVOH);
layer (f), which is based on non-water soluble polymer, preferably polyamide;
optionally, layer (g), which is based on water-soluble polymer, preferably butenediol-vinyl alcohol copolymer (BVOH) and/or polyvinyl alcohol (PVOH); and
second surface coating.

In preferred embodiments of the plastic film according to the invention, the carrier film has a layer structure selected from
(i) (a)-(c);
(ii) (a)-(b)-(c); (a)-(c)-(d); (a)-(c)-(e); (a)-(c)-(f); (a)-(c)-(g);
(iii) (a)-(b)-(c)-(d); (a)-(b)-(c)-(e); (a)-(b)-(c)-(f); (a)-(b)-(c)-(g); (a)-(c)-(d)-(e); (a)-(c)-(d)-(f); (a)-(c)-(d)-(g); (a)-(c)-(e)-(f); (a)-(c)-(e)-(g);
(iv) (a)-(b)-(c)-(d)-(e); (a)-(b)-(c)-(d)-(f); (a)-(b)-(c)-(d)-(g); (a)-(b)-(c)-(e)-(f); (a)-(b)-(c)-(e)-(g); (a)-(c)-(d)-(e)-(f); (a)-(c)-(d)-(e)-(g); (a)-(c)-(e)-(f)-(g);
(v) (a)-(b)-(c)-(d)-(e)-(f); (a)-(b)-(c)-(d)-(e)-(g); and
(vi) (a)-(b)-(c)-(d)-(e)-(f)-(g).

In preferred embodiments of the plastic film according to the invention, the plastic film has a layer structure selected from
(i) dehesive-(a)-(c);
(ii) dehesive-(a)-(b)-(c); dehesive-(a)-(c)-(d); dehesive-(a)-(c)-(e); dehesive-(a)-(c)-(f); dehesive-(a)-(c)-(g);
(iii) dehesive-(a)-(b)-(c)-(d); dehesive-(a)-(b)-(c)-(e); dehesive-(a)-(b)-(c)-(f); dehesive-(a)-(b)-(c)-(g); dehesive-(a)-(c)-(d)-(e); dehesive-(a)-(c)-(d)-(f); dehesive-(a)-(c)-(d)-(g); dehesive-(a)-(c)-(e)-(f); dehesive-(a)-(c)-(e)-(g);
(iv) dehesive-(a)-(b)-(c)-(d)-(e); dehesive-(a)-(b)-(c)-(d)-(f); dehesive-(a)-(b)-(c)-(d)-(g); dehesive-(a)-(b)-(c)-(e)-(f); dehesive-(a)-(b)-(c)-(e)-(g); dehesive-(a)-(c)-(d)-(e)-(f); dehesive-(a)-(c)-(d)-(e)-(g); dehesive-(a)-(c)-(e)-(f)-(g);
(v) dehesive-(a)-(b)-(c)-(d)-(e)-(f); dehesive-(a)-(b)-(c)-(d)-(e)-(g); and
(vi) dehesive-(a)-(b)-(c)-(d)-(e)-(f)-(g);
wherein “dehesive” stands for a dehesive surface coating.

In preferred embodiments of the plastic film according to the invention, the plastic film has a layer structure selected from
(i) dehesive-(a)-(c)-dehesive;
(ii) dehesive-(a)-(b)-(c)-dehesive; dehesive-(a)-(c)-(d)-dehesive; dehesive-(a)-(c)-(e)-dehesive; dehesive-(a)-(c)-(f)-dehesive; dehesive-(a)-(c)-(g)-dehesive;
(iii) dehesive-(a)-(b)-(c)-(d)-dehesive; dehesive-(a)-(b)-(c)-(e)-dehesive; dehesive-(a)-(b)-(c)-(f)-dehesive; dehesive-(a)-(b)-(c)-(g)-dehesive; dehesive-(a)-(c)-(d)-(e)-dehesive; dehesive-(a)-(c)-(d)-(f)-dehesive; dehesive-(a)-(c)-(d)-(g)-dehesive; dehesive-(a)-(c)-(e)-(f)-dehesive; dehesive-(a)-(c)-(e)-(g)-dehesive;
(iv) dehesive-(a)-(b)-(c)-(d)-(e)-dehesive; dehesive-(a)-(b)-(c)-(d)-(f)-dehesive; dehesive-(a)-(b)-(c)-(d)-(g)-dehesive; dehesive-(a)-(b)-(c)-(e)-(f)-dehesive; dehesive-(a)-(b)-(c)-(e)-(g)-dehesive; dehesive-(a)-(c)-(d)-(e)-(f)-dehesive; dehesive-(a)-(c)-(d)-(e)-(g)-dehesive; dehesive-(a)-(c)-(e)-(f)-(g)-dehesive;
(v) dehesive-(a)-(b)-(c)-(d)-(e)-(f)-dehesive; dehesive-(a)-(b)-(c)-(d)-(e)-(g)-dehesive; and
(vi) dehesive-(a)-(b)-(c)-(d)-(e)-(f)-(g)-dehesive;
wherein “dehesive” stands for a dehesive surface coating.

In preferred embodiments of the plastic film according to the invention, the plastic film has a layer structure selected from
(i) dehesive-(a)-(c)-adhesive;
(ii) dehesive-(a)-(b)-(c)-adhesive; dehesive-(a)-(c)-(d)-adhesive; dehesive-(a)-(c)-(e)-adhesive; dehesive-(a)-(c)-(f)-adhesive; dehesive-(a)-(c)-(g)-dehesive;
(iii) dehesive-(a)-(b)-(c)-(d)-adhesive; dehesive-(a)-(b)-(c)-(e)-adhesive; dehesive-(a)-(b)-(c)-(f)-adhesive; dehesive-(a)-(b)-(c)-(g)-adhesive; dehesive-(a)-(c)-(d)-(e)-adhesive; dehesive-(a)-(c)-(d)-(f)-adhesive; dehesive-(a)-(c)-(d)-(g)-adhesive; dehesive-(a)-(c)-(e)-(f)-adhesive; dehesive-(a)-(c)-(e)-(g)-adhesive;
(iv) dehesive-(a)-(b)-(c)-(d)-(e)-adhesive; dehesive-(a)-(b)-(c)-(d)-(f)-adhesive; dehesive-(a)-(b)-(c)-(d)-(g)-adhesive; dehesive-(a)-(b)-(c)-(e)-(f)-adhesive; dehesive-(a)-(b)-(c)-(e)-(g)-adhesive; dehesive-(a)-(c)-(d)-(e)-(f)-adhesive; dehesive-(a)-(c)-(d)-(e)-(g)-adhesive; dehesive-(a)-(c)-(e)-(f)-(g)-adhesive;
(v) dehesive-(a)-(b)-(c)-(d)-(e)-(f)-adhesive; dehesive-(a)-(b)-(c)-(d)-(e)-(g)-adhesive; and (vi) dehesive-(a)-(b)-(c)-(d)-(e)-(f)-(g)-adhesive;
wherein “dehesive” stands for a dehesive surface coating and “adhesive” stands for an adhesive surface coating.

In preferred embodiments of the plastic film according to the invention, the plastic film has a layer structure selected from
(i) adhesive-(a)-(c)-dehesive;
(ii) adhesive-(a)-(b)-(c)-dehesive; adhesive-(a)-(c)-(d)-dehesive; adhesive-(a)-(c)-(e)-dehesive; adhesive-(a)-(c)-(f)-dehesive; adhesive-(a)-(c)-(g)-dehesive;
(iii) adhesive-(a)-(b)-(c)-(d)-dehesive; adhesive-(a)-(b)-(c)-(e)-dehesive; adhesive-(a)-(b)-(c)-(f)-dehesive; adhesive-(a)-(b)-(c)-(g)-dehesive; adhesive-(a)-(c)-(d)-(e)-dehesive; adhesive-(a)-(c)-(d)-(f)-dehesive; adhesive-(a)-(c)-(d)-(g)-dehesive; adhesive-(a)-(c)-(e)-(f)-dehesive; adhesive-(a)-(c)-(e)-(g)-dehesive;
(iv) adhesive-(a)-(b)-(c)-(d)-(e)-dehesive; adhesive-(a)-(b)-(c)-(d)-(f)-dehesive; adhesive-(a)-(b)-(c)-(d)-(g)-dehesive; adhesive-(a)-(b)-(c)-(e)-(f)-dehesive; adhesive-(a)-(b)-(c)-(e)-(g)-dehesive; adhesive-(a)-(c)-(d)-(e)-(f)-dehesive; adhesive-(a)-(c)-(d)-(e)-(g)-dehesive; adhesive-(a)-(c)-(e)-(f)-(g)-dehesive;
(v) adhesive-(a)-(b)-(c)-(d)-(e)-(f)-dehesive; adhesive-(a)-(b)-(c)-(d)-(e)-(g)-dehesive; and
(vi) adhesive-(a)-(b)-(c)-(d)-(e)-(f)-(g)-dehesive;
wherein “dehesive” stands for a dehesive surface coating and “adhesive” stands for an adhesive surface coating.

In further preferred embodiments, the plastic film according to the invention is a plastic film which is surface-coated on at least one face and which comprises or consists of
a carrier film having a first outer layer and a second outer layer;
a first surface coating which covers at least part of the surface of the first outer layer of the carrier film; and
optionally, a second surface coating, which optionally covers at least part of the surface of the second outer layer of the carrier film;
   wherein the carrier film comprises
   (A) optionally, a layer (A) which contains or is based on non-water-soluble polymer, preferably polyolefin, polyester, and/or polyamide;
   (B) optionally an adhesion promoter layer (B);
   (C) optionally, a layer (C) containing or based on non-water-soluble polymer, preferably polyolefin, polyester, and/or polyamide;
   (D) optionally an adhesion promoter layer (D); and
   (E) optionally, a layer (E) which contains or is based on non-water-soluble polymer, preferably polyolefin, polyester, and/or polyamide;
   (F) optionally an adhesion promoter layer (F);
   (G) optionally, a layer (G) containing or based on non-water-soluble polymer, preferably polyolefin, polyester, and/or polyamide;
   (H) optionally, an adhesion promoter layer (H);
   wherein either the layer (A) or the adhesion promoter layer (B) forms the first outer layer of the carrier film and wherein at least one of the layers (A) to (H) and/or the first surface coating contains water-soluble polymer, preferably butenediol-vinyl alcohol copolymer (BVOH) and/or polyvinyl alcohol (PVOH), optionally in a mixture with non-water-soluble polymer, preferably polyolefin, polyester, and/or polyamide.

The first surface coating as well as layer (A) or the adhesion promoter layer (B) of the plastic film according to the invention are necessarily present. The second surface coating and layers (C), (D), (E), (F), (G), and (H) are each independently optional. Preferably, those of the existing layers are arranged in alphabetical order.

According to these embodiments of the invention, at least one of the layers (A) to (H) and/or the first surface coating contains water-soluble polymer, preferably butenediol-vinyl alcohol copolymer (BVOH) and/or polyvinyl alcohol (PVOH), optionally in a mixture with non-water-soluble polymer, preferably polyolefin, polyester, and/or polyamide. The presence of the water-soluble polymer does not significantly impair the functionality of the plastic film according to the invention or of the respective layer when it is used as intended, e.g. as a release film with release properties. However, if the plastic film according to the invention is fed into methods for the recovery of used raw materials (recycling), the content of water-soluble polymer in at least one layer of layers (A) to (H) contributes significantly to the creation of a type of “predetermined breaking point” and the ability of individual components of the plastic film to be separated from one another.

In preferred embodiments, layer (A) and/or layer (C) and/or layer (E) and/or layer (G) each independently contains a mixture of non-water-soluble polymer and water-soluble polymer.

Preferably, the non-water-soluble polymer is independently selected from the group consisting of polyolefins, polyesters, and polyamides.

Preferably, the water-soluble polymer is selected from polymers or copolymers of vinyl acetate, vinylpyrrolidone, ethylene oxide, acrylamide, and lactic acid; preferably polymers or copolymers of vinyl acetate.

Preferably, the water-soluble polymer is independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, the water-soluble polymer has an ethylene group content of at most 10 mol %, more preferably at most 5.0 mol %, even more preferably at most 2.5 mol %, and in particular practically no ethylene groups at all.

Preferably, the water-soluble polymer has a vinyl ester group content of at most 20 mol %, more preferably at most 15 mol %, even more preferably at most 10 mol %, most preferably at most 5.0 mol %, and in particular at most 2.5 mol %.

The water-soluble polymer preferably has a vinyl alcohol group content in the range from 40 to 85 mol %, preferably 50 to 75 mol %.

The water-soluble polymer preferably has a butylene group content in the range from 15 to 60 mol %, preferably 25 to 50 mol %.

Preferably, the content of water-soluble polymer is greater than the content of non-water-soluble polymer.

Preferably, the relative weight ratio of water-soluble polymer to non-water-soluble polymer is a ratio from 10:1 to 1:10, preferably 8:1 to 1:8, more preferably 6:1 to 1:6, even more preferably 4:1 to 1:4, most preferably 3:1 to 1:3, and in particular 2:1 to 1:2.

Preferably, the relative weight ratio of water-soluble polymer to non-water-soluble polymer is a ratio from 11:1 to 1:2, preferably 10:1 to 1:1, more preferably 9:1 to 2:1, even more preferably 8:1 to 3:1, most preferably 7:1 to 4:1, and in particular 6:1 to 5:1.

In preferred embodiments, based on the weight of the respective layer (A), (C), (E) or (G), independently of one another,
the content of water-soluble polymer is in the range from 85±14% by weight, preferably 85±12% by weight, more preferably 85-10% by weight, even more preferably 85-8.0% by weight, most preferably 85±6.0% by weight, and in particular 85±4.0% by weight; and
the content of non-water-soluble polymer is in the range from 15±14% by weight, preferably 15±12% by weight, more preferably 15=10% by weight, even more preferably 15±8.0% by weight, most preferably 15±6.0% by weight, and in particular 15=4.0% by weight.

Preferably, layer (A) and/or layer (C) and/or layer (E) and/or layer (G) each independently has a layer thickness in the range from 0.5 to 100 μm, preferably 0.5 to 25 μm.

Preferably, layer (A) and/or layer (C) and/or layer (E) and/or layer (G) each independently has a layer thickness of at least 1.0 μm, more preferably at least 2.0 μm, even more preferably at least 3.0 μm, most preferably at least 4.0 μm, and in particular at least 5.0 μm.

Preferably, layer (A) and/or layer (C) and/or layer (E) and/or layer (G) each independently has a layer thickness of at most 22 μm, more preferably at most 19 μm, even more preferably at most 16 μm, most preferably at most 13 μm, and in particular at most 10 μm.

In preferred embodiments, the adhesion promoter layer (B) and/or the adhesion promoter layer (D) and/or the adhesion promoter layer (F) and/or the adhesion promoter layer (H) each independently contains a mixture of non-water-soluble polymer and water-soluble polymer.

Preferably, the non-water-soluble polymer is independently selected from anhydride-modified and acid-modified polyolefin.

Preferably, the water-soluble polymer is selected from polymers or copolymers of vinyl acetate, vinylpyrrolidone, ethylene oxide, acrylamide, and lactic acid; preferably polymers or copolymers of vinyl acetate.

Preferably, the water-soluble polymer is independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, the water-soluble polymer has an ethylene group content of at most 10 mol %, more preferably at most 5.0 mol %, even more preferably at most 2.5 mol %, and in particular practically no ethylene groups at all.

Preferably, the water-soluble polymer has a vinyl ester group content of at most 20 mol %, more preferably at most 15 mol %, even more preferably at most 10 mol %, most preferably at most 5.0 mol %, and in particular at most 2.5 mol %.

The water-soluble polymer preferably has a vinyl alcohol group content in the range from 40 to 85 mol %, preferably 50 to 75 mol %.

The water-soluble polymer preferably has a butylene group content in the range from 15 to 60 mol %, preferably 25 to 50 mol %.

Preferably, the content of water-soluble polymer is greater than the content of non-water-soluble polymer.

Preferably, the relative weight ratio of water-soluble polymer to non-water-soluble polymer is a ratio from 10:1 to 1:10, preferably 8:1 to 1:8, more preferably 6:1 to 1:6, even more preferably 4:1 to 1:4, most preferably 3:1 to 1:3, and in particular 2:1 to 1:2.

Preferably, the relative weight ratio of water-soluble polymer to non-water-soluble polymer is a ratio from 11:1 to 1:2, preferably 10:1 to 1:1, more preferably 9:1 to 2:1, even more preferably 8:1 to 3:1, most preferably 7:1 to 4:1, and in particular 6:1 to 5:1.

In preferred embodiments, based on the weight of the respective adhesion promoter layer (B), (D), (F) or (H), independently of one another,
the content of water-soluble polymer is in the range from 85=14% by weight, preferably 85±12% by weight, more preferably 85±10% by weight, even more preferably 85±8.0% by weight, most preferably 85±6.0% by weight, and in particular 85±4.0% by weight; and
the content of non-water-soluble polymer is in the range from 15±14% by weight, preferably 15±12% by weight, more preferably 15=10% by weight, even more preferably 15±8.0% by weight, most preferably 15±6.0% by weight, and in particular 15±4.0% by weight.

Preferably, the adhesion promoter layer (B) and/or the adhesion promoter layer (D) and/or the adhesion promoter layer (F) and/or the adhesion promoter layer (H) each independently has a layer thickness in the range from 0.5 to 25 μm, preferably 0.5 to 10 μm.

Preferably, the adhesion promoter layer (B) and/or the adhesion promoter layer (D) and/or the adhesion promoter layer (F) and/or the adhesion promoter layer (H) each independently has a layer thickness of at least 1.0 μm, more preferably at least 2.0 μm, even more preferably at least 3.0 μm, most preferably at least 4.0 μm, and in particular at least 5.0 μm.

Preferably, the adhesion promoter layer (B) and/or the adhesion promoter layer (D) and/or the adhesion promoter layer (F) and/or the adhesion promoter layer (H) each independently has a layer thickness of at most 9.0 μm, more preferably at most 8.0 μm, even more preferably at most 7.0 μm, most preferably at most 6.0 μm, and in particular at most 5.0 μm.

Preferably, layer (B) is disposed between layer (A) and layer (C); preferably, it is in direct contact with layer (A) and/or with layer (C).

Preferably, layer (C) is disposed between layer (B) and layer (D); preferably, it is in direct contact with layer (B) and/or with layer (D).

Preferably, layer (D) is disposed between layer (C) and layer (E); preferably, it is in direct contact with layer (C) and/or with layer (E).

Preferably, layer (E) is disposed between layer (D) and layer (F); preferably, it is in direct contact with layer (D) and/or with layer (F).

Preferably, layer (F) is disposed between layer (E) and layer (G); preferably, it is in direct contact with layer (E) and/or with layer (G).

Preferably, layer (G) is disposed between layer (F) and layer (H); preferably, it is in direct contact with layer (F) and/or with layer (H).

In preferred embodiments, the plastic film according to the invention has the following structure:
first surface coating;
adhesion promoter layer (B) which forms the first outer layer of the carrier film; wherein the adhesion promoter layer (B) is preferably based on a water-soluble polymer which is present in a mixture with an adhesion promoter;
layer (C), which contains or is based on non-water soluble polymer, preferably polypropylene;
adhesion promoter layer (D); wherein the adhesion promoter layer (D) is preferably based on a water-soluble polymer, preferably butenediol-vinyl alcohol copolymer (BVOH) and/or polyvinyl alcohol (PVOH), which is present in a mixture with an adhesion promoter;
layer (E), which contains or is based on non-water soluble polymer, preferably polypropylene;
adhesion promoter layer (F); wherein the adhesion promoter layer (F) is preferably based on a water-soluble polymer, preferably butenediol-vinyl alcohol copolymer (BVOH) and/or polyvinyl alcohol (PVOH), which is present in a mixture with an adhesion promoter;
layer (G), which contains or is based on non-water soluble polymer, preferably polypropylene;
adhesion promoter layer (H); wherein the adhesion promoter layer (H) is preferably based on a water-soluble polymer, preferably butenediol-vinyl alcohol copolymer (BVOH) and/or polyvinyl alcohol (PVOH), which is present in a mixture with an adhesion promoter;
second surface coating.

In preferred embodiments, the first surface coating contains a mixture of polysiloxane and water-soluble polymer, preferably butenediol-vinyl alcohol copolymer (BVOH) and/or polyvinyl alcohol (PVOH).

Preferably, the polysiloxane is selected from the group consisting of addition-crosslinked, preferably metal-catalyzed addition-crosslinked, condensation-crosslinked, radically crosslinked, and/or cationically crosslinked, polysiloxanes.

Preferably, the polysiloxane is selected from the group consisting of polydialkylsiloxanes, preferably polydimethylsiloxanes, and polyalkylarylsiloxanes, preferably polymethylphenylsiloxanes.

Preferably, the water-soluble polymer is selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH).

Preferably, the relative weight ratio of water-soluble polymer to polysiloxane is a ratio from 10:1 to 1:10, preferably 8:1 to 1:8, more preferably 6:1 to 1:6, even more preferably 4:1 to 1:4, most preferably 3:1 to 1:3, and in particular 2:1 to 1:2.

In preferred embodiments, the total content of water-soluble polymer contained in the plastic film, based on the total weight of the plastic film, is at least 0.5% by weight, more preferably at least 1.0% by weight, even more preferably at least 2.0% by weight, most preferably at least 3.0% by weight and in particular at least 4.0% by weight.

In preferred embodiments, the total content of water-soluble polymer contained in the plastic film, based on the total weight of the plastic film, is at most 18% by weight, more preferably at most 16% by weight, even more preferably at most 14% by weight, most preferably at most 12% by weight, and in particular at most 10% by weight.

In preferred embodiments, the total content of water-soluble polymer contained in the plastic film, based on the total weight of the plastic film, is at most 10% by weight, more preferably at most 9.0% by weight, even more preferably at most 8.0% by weight, most preferably at most 7.0% by weight, and in particular at most 6.0% by weight.

All layers of the carrier film according to the invention can contain conventional additives in conventional quantities. Common additives are selected from the group consisting of fillers, such as CaCO₃, layered silicates, such as talc, plasticizers; lubricants; emulsifiers; pigments; rheology additives; catalysts; flow control agents; impact modifiers, optical brighteners; light stabilizers; antioxidants; clarifying agents, such as substituted or unsubstituted bisbenzylidene sorbitols; flame retardants; antistatic agents; UV absorbers, such as benzoxazinones; blowing agents; and thiosynergists, such as thiodipropionic acid dilauryl esters or thiodipropionic acid distearyl esters. A preferred plasticizer for water-soluble polymers is glycerin.

The carrier layer according to the invention can be produced by conventional methods known to those skilled in the art and can then be provided with the first surface coating on the first outer face. Preferred methods are blown film extrusion or casting methods.

The layers can be applied to the substrate (precursor of the carrier film) by coextrusion (film extrusion), as a polymer coating (extrusion coating) or as an independent coating (coating, print, varnish) before the first and possibly second surface coating (silicone, adhesive, etc.). To ensure sufficient bonding, additional adjustments familiar to a person skilled in the art may be necessary, such as corona treatment.

The plastic film according to the invention can be subjected to conventional recycling processes, which typically include treatment in a water bath. Due to the inventive structure of the plastic film, it is now possible to dissolve the water-soluble layer or the water-soluble polymers (almost) completely without residue during the recycling process. As a result, the first and second surface coatings (silicone, adhesive, etc.) lose their adhesion to the substrate and are washed away. The substrate can then be separated from the wash water as the main raw material, for example by density gradients. The detached surface coating is considered a contaminant and is removed or otherwise treated. The resulting aqueous waste, which contains the water-soluble polymer, is easy to dispose of when biodegradable and non-environmentally hazardous materials are used and does not negatively affect the sustainability of the new film design.

Another aspect of the invention relates to a method for producing a plastic film according to the invention as described above by blown film coextrusion.

In the method according to the invention, the extrusion of the plastic film preferably takes place in one step.

Another aspect of the invention relates to a plastic film obtainable by the inventive method described above.

Another aspect of the invention relates to the use of the above-described plastic film according to the invention for recycling some of its constituents. Preferably, the plastic film is split along at least one layer which contains or is based on water-soluble polymer, preferably butenediol-vinyl alcohol copolymer (BVOH) and/or polyvinyl alcohol (PVOH), after or while being treated in a water bath, optionally at an elevated temperature and after a sufficient exposure time.

The functioning of the invention will be explained schematically using FIGS. 1 and 2.

### BRIEF DESCRIPTION OF THE DRAWINGS

FIG. 1 shows a schematic cross-section of a plastic film according to the invention with a first surface coating (1), a layer (2) based on a water-soluble polymer, e.g. BVOH/PVOH, a layer (3) based on an adhesion promoter, e.g. PP+MAH, and a layer (4) based on a non-water-soluble polymer, e.g. PA.

FIG. 2 shows the treatment of the plastic film shown in FIG. 1 in a container (5) filled with warm water (6). The water-soluble polymer dissolves in the water (6), so that the water-soluble polymer-based layer (2) is dissolved. As a result, the first surface coating (1) detaches, floats to the water surface and can be disposed of separately or recycled. The separated composite consisting of the layer (3) based on an adhesion promoter and a layer (4) based on a non-water-soluble polymer can then be subjected to recycling.

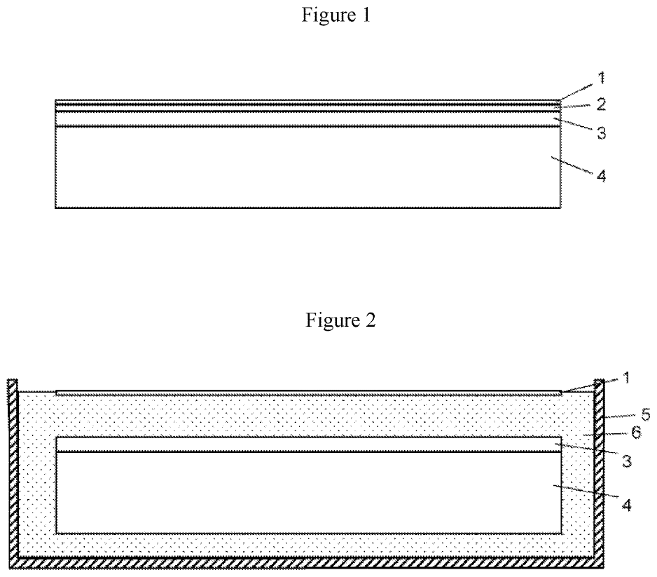

The following examples serve to illustrate the invention but are not to be interpreted as limiting.

### Example 1

Multilayer carrier films are produced by blown film co-extrusion and then provided on one face with a cured polysiloxane coating to provide a dehesive effect. The individual layers are directly adjacent to each other in the order in which they are listed in the table below:

| | | Raw materials | V-1 | | B-1 | |
|---|---|---|---|---|---|---|
| 1 | | cured polysiloxane | 1.0 | μm | 1.0 | μm |
| 2 | (a) | 100% by weight BVOH/PVOH (Nichigo OKS 8074 P) | — | | 1.5 | μm |
| 3 | (c₁) | 39% by weight LDPE (Lupolen 2420 F) | 5.0 | μm | 3.5 | μm |
| | | 25% by weight LLDPE (Innovex LL 6910) | | | | |
| | | 19% by weight chalk batch (Multibatch ME 50009) | | | | |
| | | 15% by weight polybutylene (Polybuten 8640 M) | | | | |
| | | 2.0% by weight color masterbatch (70% TiO₂, Remafin Weiss RCL) | | | | |
| 4 | (c₂) | 56% by weight LDPE (Lupolen 2420 F) | 15 | μm | 15 | μm |
| | | 22.5% by weight chalk batch (Multibatch ME 50009) | | | | |
| | | 19.5% by weight LLDPE (Innovex LL 6910) | | | | |
| | | 2.0% by weight color masterbatch (70% TiO₂, Remafin Weiss RCL) | | | | |
| 5 | (c₃) | 39% by weight LDPE (Lupolen 2420 F) | 5.0 | μm | 5.0 | μm |

25% by weight LLDPE (Innovex LL 6910)
19% by weight chalk batch (Multibatch ME 50009)
15% by weight polybutylene (Polybuten 8640 M)
2.0% by weight color masterbatch (70% TiO₂, Remafin Weiss RCL)

### Example 2

Multilayer carrier films are produced by blown film co-extrusion and then provided on one face with a cured polysiloxane coating to provide a dehesive effect. The individual layers are directly adjacent to each other in the order in which they are listed in the table below:

| | | Raw materials | V-2 | | B-2 | |
|---|---|---|---|---|---|---|
| 1 | | cured polysiloxane | 1.0 | μm | 1.0 | μm |
| 2 | (a) | 100% by weight BVOH/PVOH (Nichigo OKS 8074 P) | — | | 1.5 | μm |
| 3 | (b) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 4 | (c) | 48.25% by weight PP copolymer (Inspire 137) | 21.5 | μm | 20 | μm |

48.25% by weight PP homopolymer (Borealis HC 113 BF)
3.0% by weight phyllosilicate (Talcolin 60 PP XF)
0.5% by weight fluoroelastomer on LDPE (Luvobatch PE PPA 9679)

### Example 3

Multilayer carrier films are produced by blown film co-extrusion and then provided on one face with a cured polysiloxane coating to provide a dehesive effect and a pressure-sensitive adhesive to provide an adhesive effect. The individual layers are directly adjacent to each other in the order in which they are listed in the table below:

| | | Raw materials | V-3 | | B-3 | |
|---|---|---|---|---|---|---|
| 1 | | cured polysiloxane | 1.0 | μm | 1.0 | μm |
| 2 | (a) | 100% by weight BVOH/PVOH (Nichigo OKS 8074 P) | — | | 1.5 | μm |
| 3 | (b) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 4 | (c) | 48.25% by weight PP copolymer (Inspire 137) | 23 | μm | 20 | μm |
| | | 48.25% by weight PP homopolymer (Borealis HC 113 BF) | | | | |
| | | 3.0% by weight phyllosilicate (Talcolin 60 PP XF) | | | | |
| | | 0.5% by weight fluoroelastomer on LDPE (Luvobatch PE PPA 9679) | | | | |
| 5 | (d) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 6 | (e) | 100% by weight BVOH/PVOH (Nichigo OKS 8074 P) | — | | 1.5 | μm |
| 7 | | pressure-sensitive adhesive | 3.5 | μm | 3.5 | μm |

### Example 4

Multilayer carrier films are produced by blown film co-extrusion and then provided on one face with a cured polysiloxane coating to provide a dehesive effect. The individual layers are directly adjacent to each other in the order in which they are listed in the table below:

| | | Raw materials | V-4 | | B-4 | |
|---|---|---|---|---|---|---|
| 1 | | cured polysiloxane | 1.0 | μm | 1.0 | μm |
| 2 | (a) | 100% by weight BVOH/PVOH (Nichigo OKS 8074 P) | — | | 1.5 | μm |
| 3 | (b) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 4 | (c) | 48.25% by weight PP copolymer (Inspire 137) | 23 | μm | 20 | μm |
| | | 48.25% by weight PP homopolymer (Borealis HC 113 BF) | | | | |
| | | 3.0% by weight phyllosilicate (Talcolin 60 PP XF) | | | | |
| | | 0.5% by weight fluoroelastomer on LDPE (Luvobatch PE PPA 9679) | | | | |
| 5 | (d) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 6 | (e) | 100% by weight BVOH/PVOH (Nichigo OKS 8074 P) | — | | 1.5 | μm |
| 7 | (f) | 100% by weight PA (Durethan C 38 F) | 10 | μm | 10 | μm |

### Example 5

Multilayer carrier films are produced by blown film co-extrusion and then provided on one face with a cured polysiloxane coating to provide a dehesive effect and a pressure-sensitive adhesive to provide an adhesive effect. The individual layers are directly adjacent to each other in the order in which they are listed in the table below:

| | | Raw materials | V-5 | | B-5 | |
|---|---|---|---|---|---|---|
| 1 | | cured polysiloxane | 1.0 | μm | 1.0 | μm |
| 2 | (a) | 100% by weight BVOH/PVOH (Nichigo OKS 8074 P) | — | | 1.5 | μm |
| 3 | (b) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 4 | (c) | 48.25% by weight PP copolymer (Inspire 137) | 23 | μm | 20 | μm |
| | | 48.25% by weight PP homopolymer (Borealis HC 113 BF) | | | | |
| | | 3.0% by weight phyllosilicate (Talcolin 60 PP XF) | | | | |
| | | 0.5% by weight fluoroelastomer on LDPE (Luvobatch PE PPA 9679) | | | | |
| 5 | (d) | 50% by weight PP-MAH (Admer QB 520 E) | 3.5 | μm | 3.5 | μm |
| | | 30% by weight impact strength modifier (Lucofin 1400 HN) | | | | |
| | | 20% by weight PP homopolymer (Borealis HC 113 BF) | | | | |
| 6 | (e) | 100% by weight BVOH/PVOH (Nichigo OKS 8074 P) | — | | 1.5 | μm |
| 7 | (f) | 100% by weight PA (Durethan C 38 F) | 11.5 | μm | 10 | μm |
| 8 | (g) | 100% by weight BVOH/PVOH (Nichigo OKS 8074 P) | — | | 1.5 | μm |
| 9 | | pressure-sensitive adhesive | 3.5 | μm | 3.5 | μm |

### Example 6

A multilayer carrier film is produced by blown film co-extrusion and then provided on one face with a cured polysiloxane coating to provide a dehesive effect and a pressure-sensitive adhesive to provide an adhesive effect. The individual layers are directly adjacent to each other in the order in which they are listed in the table below:

| | | Raw materials | B-6 | |
|---|---|---|---|---|
| 1 | | cured polysiloxane | 1.0 | μm |
| 2 | (B) | 15% by weight PP + MAH (Bynel 46E 1060) | 3.5 | μm |
| | | 85% by weight BVOH/PVOH (Nichigo OKS 8074 P) | | |
| 3 | (C) | 48.25% by weight PP copolymer (Inspire 137) | 21.5 | μm |
| | | 48.25% by weight PP homopolymer (Borealis HC 113 BF) | | |
| | | 3.0% by weight phyllosilicate (Talcolin 60 PP XF) | | |
| | | 0.5% by weight fluoroelastomer on LDPE (Luvobatch PE PPA 9679) | | |
| 4 | (D) | 15% by weight PP + MAH (Bynel 46E 1060) | 3.5 | μm |
| | | 85% by weight BVOH/PVOH (Nichigo OKS 8074 P) | | |
| 5 | (E) | 100% by weight PA (Durethan C 38 F) | 10 | μm |
| 6 | (F) | 15% by weight PP + MAH (Bynel 46E 1060) | 3.5 | μm |
| | | 85% by weight BVOH/PVOH (Nichigo OKS 8074 P) | | |
| 7 | (G) | 48.25% by weight PP copolymer (Inspire 137) | 21.5 | μm |
| | | 48.25% by weight PP homopolymer (Borealis HC 113 BF) | | |
| | | 3.0% by weight phyllosilicate (Talcolin 60 PP XF) | | |
| | | 0.5% by weight fluoroelastomer on LDPE (Luvobatch PE PPA 9679) | | |
| 8 | (H) | 15% by weight PP + MAH (Bynel 46E 1060) | 3.5 | μm |
| | | 85% by weight BVOH/PVOH (Nichigo OKS 8074 P) | | |
| 9 | | pressure-sensitive adhesive | 3.5 | μm |

What is claimed is:

1. A plastic film with a surface coating on at least one face, which comprises or consists of
a carrier film having a first outer layer and a second outer layer;
a first surface coating which covers at least part of the surface of the first outer layer of the carrier film; and
optionally, a second surface coating, which optionally covers at least part of the surface of the second outer layer of the carrier film;
wherein
the carrier film comprises at least one layer which contains or is based on non-water-soluble polymer, preferably polyolefin, polyester, and/or polyamide; and
the plastic film contains water-soluble polymer, preferably butenediol-vinyl alcohol copolymer (BVOH) and/or polyvinyl alcohol (PVOH), more preferably butenediol-vinyl alcohol copolymer (BVOH); wherein
(i) the carrier film comprises at least one layer which contains or is based on water-soluble polymer, and/or
(ii) the first surface coating contains or is based on water-soluble polymer, preferably butenediol-vinyl alcohol copolymer (BVOH) and/or polyvinyl alcohol (PVOH).

2. (canceled)

3. The plastic film of claim 1, wherein the first surface coating is based on polysiloxane.

4. The plastic film of claim 1, wherein the first surface coating is based on at least one cured polysiloxane, which is optionally preferably-selected from the group consisting of addition-crosslinked, preferably metal-catalyzed addition-crosslinked, condensation-crosslinked, radically crosslinked, and/or cationically crosslinked, polysiloxanes.

5. The plastic film of claim 1, wherein the first surface coating is based on at least one cured polysiloxane, which is optionally selected from the group consisting of polydialkylsiloxanes, preferably polydimethylsiloxanes, and polyalkylarylsiloxanes, preferably polymethylphenylsiloxanes.

6. The plastic film of claim 1, wherein the first surface coating is adhesive; wherein the first surface coating is based on a pressure-sensitive adhesive;
optionally, wherein the pressure-sensitive adhesive is selected from the group consisting of acrylate-based pressure-sensitive adhesives, rubber-based pressure-sensitive adhesives, polyisobutylene-based pressure-sensitive adhesives, and hot melts.

7. (canceled)

8. (canceled)

9. The plastic film of claim 1, wherein the first surface coating is based on printing ink or varnish.

10. The plastic film of claim 1, wherein the first surface coating
(i) is dehesive and has a weight per unit area of at most 5.0 g/m2, more preferably at most 4.0 g/m2, even more preferably at most 3.0 g/m2, most preferably at most 2.0 g/m2 and in particular at most 1.0 g/m2; or
(ii) is adhesive and has a weight per unit area of at most 100 g/m2, more preferably at most 80 g/m2, even more preferably at most 60 g/m2, most preferably at most 40 g/m2, and in particular at most 20 g/m2.

11. (canceled)

12. The plastic film of claim 1, wherein the second surface coating is based on polysiloxane.

13. The plastic film of claim 3, wherein the second surface coating is based on at least one cured polysiloxane, which is selected from the group consisting of addition-crosslinked, preferably metal-catalyzed addition-crosslinked, condensation-crosslinked, radically crosslinked, and/or cationically crosslinked, polysiloxanes; or
wherein the second surface coating is based on at least one cured polysiloxane, which is preferably selected from the group consisting of polydialkylsiloxanes, optionally polydimethylsiloxanes, and polyalkylarylsiloxanes, preferably polymethylphenylsiloxanes.

14. (canceled)

15. (canceled)

16. (canceled)

17. (canceled)

18. (canceled)

19. The plastic film of claim 1, wherein the second surface coating
(i) is dehesive and has a weight per unit area of at most 5.0 g/m2, more preferably at most 4.0 g/m2, even more preferably at most 3.0 g/m2, most preferably at most 2.0 g/m2 and in particular at most 1.0 g/m2; or
(ii) is adhesive and has a weight per unit area of at most 100 g/m2, more preferably at most 80 g/m2, even more preferably at most 60 g/m2, most preferably at most 40 g/m2, and in particular at most 20 g/m2.

20. The plastic film of claim 1, wherein the plastic film has a total layer thickness in the range from 10 to 250 μm.

21. (canceled)

22. (canceled)

23. The plastic film of claim 1, wherein the plastic film is extruded in one step, by blown film coextrusion;
optionally wherein the carrier film has a symmetrical layer structure.

24. (canceled)

25. The plastic film of claim 1, wherein the carrier film
(a) a layer (a) which is based on water-soluble polymer, preferably butenediol-vinyl alcohol copolymer (BVOH) and/or polyvinyl alcohol (PVOH), and forms the first outer layer of the carrier film;
(b) optionally an adhesion promoter layer (b);
(c) a layer (c) based on non-water-soluble polymer, preferably polyolefin, polyester, and/or polyamide;
(d) optionally an adhesion promoter layer (d);
(e) optionally, a layer (e) which is based on water-soluble polymer, preferably butenediol-vinyl alcohol copolymer (BVOH) and/or polyvinyl alcohol (PVOH);
(f) optionally, a layer (f) which is based on non-water-soluble polymer, preferably polyolefin, polyester, and/or polyamide;
(g) optionally, a layer (g) which is based on water-soluble polymer, preferably butenediol-vinyl alcohol copolymer (BVOH) and/or polyvinyl alcohol (PVOH).

26. The plastic film of claim 25, wherein
the layer (a) is based on extrudable, water-soluble polymer, preferably butenediol-vinyl alcohol copolymer (BVOH) and/or polyvinyl alcohol (PVOH); and/or
the layer (a) is based on one or more water-soluble polymers independently selected from
(i) fully synthetic water-soluble polymers;
(ii) semi-synthetic or natural water-soluble polymers; and/or
the layer (a) is based on one or more water-soluble polymers selected from polymers or copolymers of vinyl acetate, vinylpyrrolidone, ethylene oxide, acrylamide, and lactic acid; preferably polymers or copolymers of vinyl acetate; and/or
the layer (a) is based on one or more water-soluble polymers independently selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH); and/or
the layer (a) is based on one or more water-soluble polymers having an ethylene group content of at most 10 mol %; and/or
the layer (a) contains at least 50% by weight water-soluble polymer; and/or
the layer (a) contains at most 10% by weight of non-water-soluble polymer.

27-102. (canceled)

103. The plastic film of claim 1, wherein the carrier film comprises or consists of
(A) optionally, a layer (A) which contains or is based on non-water-soluble polymer, preferably polyolefin, polyester, and/or polyamide;
(B) optionally an adhesion promoter layer (B);
(C) optionally, a layer (C) containing or based on non-water-soluble polymer, preferably polyolefin, polyester, and/or polyamide;
(D) optionally an adhesion promoter layer (D);
(E) optionally, a layer (E) which contains or is based on non-water-soluble polymer, preferably polyolefin, polyester, and/or polyamide;
(F) optionally an adhesion promoter layer (F);
(G) optionally, a layer (G) containing or based on non-water-soluble polymer, preferably polyolefin, polyester, and/or polyamide;
(H) optionally, an adhesion promoter layer (H);
wherein either the layer (A) or the adhesion promoter layer (B) forms the first outer layer of the carrier film.

104. The plastic film of claim 103, wherein the layer (A) and/or the layer (C) and/or the layer (E) and/or the layer (G) each independently contains a mixture of non-water-soluble polymer, preferably polyolefin, polyester and/or polyamide, and water-soluble polymer, preferably butenediol-vinyl alcohol copolymer (BVOH) and/or polyvinyl alcohol (PVOH).

105-112. (canceled)

113. The plastic film of claim 103, wherein the adhesion promoter layer (B) and/or the adhesion promoter layer (D) and/or the adhesion promoter layer (F) and/or the adhesion promoter layer (H) each independently contains a mixture of non-water-soluble polymer and water-soluble polymer;
optionally wherein the non-water soluble polymer is independently selected from anhydride modified and acid modified polyolefin;
optionally wherein the water-soluble polymer is selected from polymers or copolymers of vinyl acetate, vinylpyrrolidone, ethylene oxide, acrylamide, and lactic acid; preferably polymers or copolymers of vinyl acetate;
optionally, wherein the water-soluble polymer is selected from the group consisting of butenediol-vinyl alcohol copolymer (BVOH), polyvinyl alcohol (PVOH), polyvinyl acetate (PVA), polyvinylpyrrolidone (PVP), polyethylene oxide (PEO), polyacrylamide (PAM), and polylactic acid (PLA); preferably butenediol-vinyl alcohol copolymer (BVOH);
optionally, wherein the water-soluble polymer has a water solubility of at least 5.0 g/L;
optionally, wherein the non-water-soluble polymer has a water solubility of at most 1000 mg/L.

114-132. (canceled)

133. A method for producing the plastic film of claim 1 by blown film coextrusion;
optionally wherein the extrusion of the plastic film takes place in one step.

134. (canceled)

135. (canceled)

136. A method comprising a step of recycling a part of the components of the plastic film of claim 1,
optionally, wherein the plastic film is split along at least one layer which contains or is based on water-soluble polymer, preferably butenediol-vinyl alcohol copolymer (BVOH) and/or polyvinyl alcohol (PVOH) after or during the treatment in a water bath, optionally at elevated temperature and after a sufficient exposure time.
